(19) United States
(12) Patent Application Publication
(10) Pub. No.: US 2020/0109814 A1
(43) Pub. Date: Apr. 9, 2020

(54) DISPLAY MODULE ASSEMBLY AND RIVETING COLUMN STRUCTURE ON BACK PLATE THEREOF

(71) Applicants: BOE TECHNOLOGY GROUP CO., LTD., Beijing (CN); HEFEI BOE DISPLAY TECHNOLOGY CO., LTD., Anhui (CN)

(72) Inventors: Baoyong NIE, Beijing (CN); Zhiyu QIAN, Beijing (CN); Fan PENG, Beijing (CN); Haibin LIU, Beijing (CN); Fangqing LI, Beijing (CN); Yong SUN, Beijing (CN)

(73) Assignees: BOE TECHNOLOGY GROUP CO., LTD., Beijing (CN); HEFEI BOE DISPLAY TECHNOLOGY CO., LTD., Anhui (CN)

(21) Appl. No.: 15/778,205

(22) PCT Filed: Oct. 10, 2017
(86) PCT No.: PCT/CN2017/105457

§ 371 Date: May 22, 2018

(30) Foreign Application Priority Data
Mar. 29, 2017 (CN) 201720318151.0

(51) Int. Cl. F16M 13/02; F16M 11/04; G06F 1/16; H04N 5/655

(52) U.S. Cl. CPC F16M 13/02; F16M 11/04; G06F 2200/1613; H04N 5/655; G06F 1/1601

(57) ABSTRACT

A riveting column structure on a back plate of a display module assembly and a display module assembly are disclosed. The riveting column structure on the back plate of the display module assembly includes a back plate and a riveting column. The back plate is provided with a through hole passing through the back plate's inner and outer surfaces, and a first connecting portion is provided at the through hole of the back plate. The riveting column is inserted into the through hole. A plurality of second connecting portions are provided on a side surface of the riveting column. The plurality of second connecting portions are arranged in order in a direction from a position close to an outer end of the riveting column to a position away from the outer end of the riveting column. Each of the plurality of second connecting portions is respectively connected with the first connecting portion.

### CROSS-REFERENCE TO RELATED APPLICATION

This application is the U.S. National Phase under 35 U.S.C. § 371 of International Application No. PCT/CN2017/105457, filed on Oct. 10, 2017, which claims the benefit of Chinese Application No. 201720318151.0, filed on Mar. 29, 2017, the entire contents of each are hereby incorporated by reference.

### TECHNICAL FIELD

The present disclosure relates to a field of display technology, and more particularly, to a riveting column structure on a back plate of a display module assembly and a display module assembly.

### BACKGROUND

When a display module assembly is transported, in order to avoid damage to the display module assembly, a riveting column is usually provided on a back plate of the display module assembly. The riveting column may be attached to a bracket by grasping the bracket to help the transportation of the display module assembly. In this way, it is possible to avoid damage to the display module assembly caused by direct contact between the bracket and the display module assembly during the process of transporting the display module assembly. In addition, a display module assembly in a television can also be connected to a bracket on a wall through a riveting column, so as to achieve the purpose of wall hanging of the television.

### SUMMARY

The embodiments of the present disclosure provide a riveting column structure on a back plate of a display module assembly. The riveting column structure on the back plate includes a back plate provided with a through hole passing through the back plate's inner and outer surfaces, wherein a first connecting portion is provided at the through hole of the back plate; and a riveting column inserted into the through hole, a plurality of second connecting portions are provided on a side surface of the riveting column, the plurality of second connecting portions are arranged in order in a direction from a position close to an outer end of the riveting column to a position away from the outer end of the riveting column, and each of the plurality of second connecting portions is respectively connected with the first connecting portion.

Optionally, the first connecting portion includes a hole wall of the through hole and a stop assembly, and the plurality of second connecting portions are a plurality of first grooves. One of the plurality of first grooves is cooperatively engaged with the hole wall of the through hole, and the stop assembly is configured to block a movement of the riveting column to prevent the first grooves which are cooperatively engaged with the hole wall of the through hole from being separated from the hole wall of the through hole.

Optionally, the through hole includes a first portion having a radius substantially equal to a radius of a bottom of the plurality of first grooves; and a second portion having a radius greater than or substantially equal to a radius of a top of the plurality of first grooves. The first portion and the second portion are arranged in order from top to bottom and communicate with each other, and the riveting column is able to move between the first portion and the second portion.

Optionally, the through hole includes a first portion having a radius substantially equal to a minimum radius of the plurality of first grooves; and a second portion having a radius greater than or substantially equal to a maximum radius of the plurality of first grooves; wherein, the first portion and the second portion are arranged in order from top to bottom and communicate with each other, and the riveting column is able to move between the first portion and the second portion.

Optionally, the stop assembly includes: a guide groove disposed on the back plate; a stopper slidably fitted in the guide groove; and a spring, one end of which is fixed to an inner wall of the guide groove and another end of which is connected to the stopper. In cases where one end of the stopper away from the spring is in contact with the riveting column and the spring is in a compressed state, the stopper blocks the movement of the riveting column to prevent the first grooves which are cooperatively engaged with the hole wall of the through hole from being separated from the hole wall of the through hole; and in cases where the riveting column is removed from the through hole, the stopper slides along the guide groove under the elastic force of the spring to block the through hole.

Optionally, the plurality of first grooves are a plurality of annular grooves coaxial with the riveting column, one end of the stopper away from the spring is provided with a semi-circular groove, and the one end of the stopper away from the spring is able to be snap-fitted with one of the plurality of annular grooves through the semi-circular groove.

Optionally, the guide groove is disposed on an inner surface of the back plate.

Optionally, the plurality of second connecting portions are arranged from a position close to the outer end of the riveting column to a position away from the outer end of the riveting column.

Optionally, at least one second groove is further provided on a side surface of the riveting column, and a width of each of the at least one second groove is not equal to a width of each of the plurality of first grooves.

Optionally, the back plate is provided with a reinforcing rib, and the through hole is formed on the reinforcing rib.

Optionally, a convex hull is provided on an outer surface of the back plate, and the through hole is formed on the convex hull.

The embodiments of the present disclosure also provide a display module assembly including the riveting column structure on the back plate in any one of the above technical solutions.

### BRIEF DESCRIPTION OF THE DRAWINGS

FIG. 1 is a schematic diagram of a riveting column structure on a back plate of a display module assembly;

FIG. 2 is a schematic diagram of a back plate in a riveting column structure on a back plate of a display module assembly provided in some embodiments of the present disclosure;

FIG. 3 is a partial enlarged view of FIG. 2;

FIG. 4 is a rear view of FIG. 3;

FIG. 5 is a schematic diagram of a riveting column in a riveting column structure on a back plate of a display module assembly provided in some embodiments of the present disclosure;

FIG. 6 is a front view of FIG. 5;

FIG. 7 is a schematic diagram of a riveting column structure on a back plate of a display module assembly provided in some embodiments of the present disclosure;

FIG. 8 is a schematic diagram of another riveting column structure on a back plate of a display module assembly provided in some embodiments of the present disclosure;

FIG. 9 is a rear view of FIG. 7 and FIG. 8;

FIG. 10 is a side view of FIG. 7;

FIG. 11 is a side view of FIG. 8;

FIG. 12 is a second schematic diagram of a riveting column in a riveting column structure on a back plate of a display module assembly provided in some embodiments of the present disclosure;

FIG. 13 is a front view of FIG. 12;

FIG. 14 is a schematic diagram of a second groove provided on a riveting column in a riveting column structure on a back plate of a display module assembly provided in some embodiments of the present disclosure;

FIG. 15 is a schematic diagram of a display module assembly provided in some embodiments of the present disclosure.

### DETAILED DESCRIPTION

The technical solutions in the embodiments of the present disclosure will be described clearly and completely with reference to the accompanying drawings in the embodiments of the present disclosure. Obviously, the described embodiments are merely some but not all of embodiments of the present disclosure. All other embodiments made on the basis of the embodiments of the present disclosure by a person of ordinary skill in the art without paying any creative effort shall be included in the protection scope of the present disclosure.

In the description of the present disclosure, it should be understood that, an orientation or positional relationship indicated by terms such as “center”, “upper”, “lower”, “front”, “back”, “left”, “right”, “vertical”, “horizontal”, “top”, “bottom”, “inner”, “outer”, is based on an orientation or positional relationship shown in the drawings and is used for describing the present disclosure conveniently and simply only, but does not indicate or imply that the referred devices or elements must have a particular orientation or must be constructed and operated in a particular orientation, therefore it should not be construed to limit the present disclosure.

Terms “first” and “second” are used for descriptive purposes only but not to be construed as indicating or implying relative importance or implicitly indicating the number of technical features referred by these terms. Thus, features defined by “first”, “second” may explicitly or implicitly include one or more of these features. In the description of the present disclosure, “a plurality” means two or more, unless otherwise specified.

In the description of the present disclosure, it should be noted that terms “install”, “connect”, and “couple” should be interpreted broadly unless specifically defined or limited otherwise. For example, they may refer to fixed connections, alternatively, they may refer to detachable connections or integrally connections; they may refer to direct connections or indirect connections through the intermediary, alternatively, they may refer to the internal communication of two components. For a person of ordinary skill in the art, the specific meanings of the above terms in the present disclosure can be understood in specific situations.

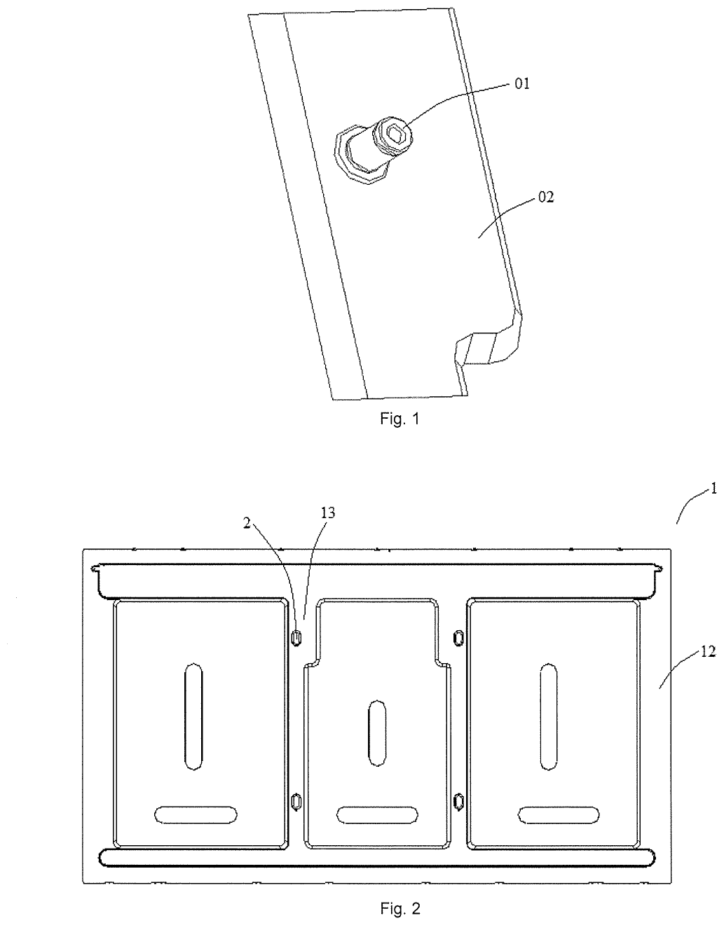

Generally, as shown in FIG. 1, a riveting column 01 is non-detachably fixed on an outer surface of a back plate 02. Since the riveting column is relatively long, and sometimes it may occupy one-half a thickness of a whole display module assembly, it will result in a relatively large thickness of the whole display module assembly. Therefore, the space occupied by the display module assembly during a packaging process and a transportation process is relatively large, which in turn leads to an increase in a packaging cost and a transportation cost. In addition, it is easy for a relatively long riveting column to scratch a packaging bag, and to get knocked or be knocked off during a transportation process.

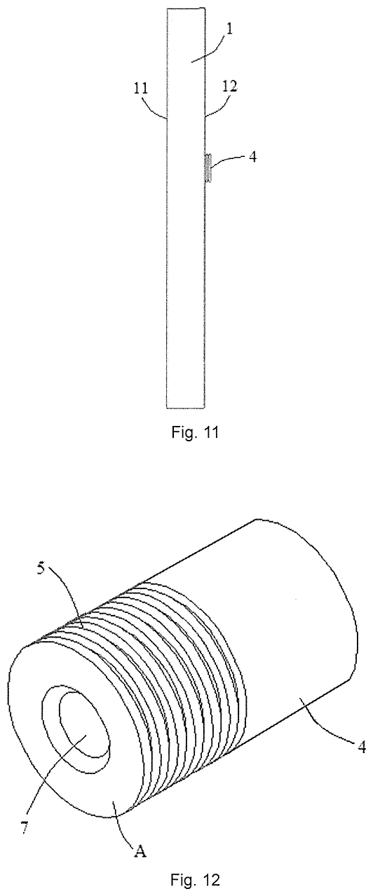

In order to solve the problems due to the relatively long riveting column such as the packaging cost and the transportation cost being increased, the packaging bag being easily scratched, and the riveting column being easily to get knocked or be knocked off, referring to FIG. 2 to FIG. 14, a riveting column structure on a back plate of a display module assembly is provided in some embodiments of the present disclosure. The riveting column structure on a back plate includes a back plate 1 and a riveting column 4. The back plate 1 is provided with a through hole 2 passing through the back plate's inner and outer surfaces. A first connecting portion 3 is provided at the through hole 2 of the back plate 1. The riveting column 4 is inserted into the through hole 2. A plurality of second connecting portions 5 are provided on a side surface of the riveting column 4. The plurality of second connecting portions 5 are arranged in order in a direction from a position close to an outer end A of the riveting column 4 to a position away from the outer end A of the riveting column 4, and each of the plurality of second connecting portions 5 may be respectively connected with the first connecting portion 3. It should be noted that the outer end A of the riveting column 4 refers to an end of the riveting column 4 towards the outside of the back plate 1.

In the riveting column structure on the back plate of the display module assembly provided in some embodiments of the present disclosure, the back plate 1 is provided with the through hole 2 passing through the back plate's inner and outer surfaces; the back plate 1 is provided with a first connecting portion 3 at the through hole 2; the riveting column 4 is inserted into the through hole 2; the plurality of second connecting portions 5 are provided on the side surface of the riveting column 4; the plurality of second connecting portions 5 are arranged in order in a direction from the position close to the outer end A of the riveting column 4 to the position away from the outer end A of the riveting column 4, and each of the plurality of second connecting portions 5 may be respectively connected with the first connecting portion 3. Therefore, when the riveting column 4 is required to be connected with a bracket (not shown in the figures), one of the plurality of second connecting portions 5, which is far away from the outer end A of the riveting column 4, is connected with the first connecting portion 3, so that a portion of the riveting column 4 exposed outside the back plate 1 is long, thereby the connection with the bracket is facilitated. When the display module assembly is packaged and transported, one of the plurality of second connecting portions 5 close to the outer end A of the riveting column 4 may be connected with the first connecting portion 3, so that a portion of the riveting column 4 exposed outside the back plate 1 is short, thereby an overall thickness of the display module assembly is reduced. Accordingly, the space occupied by the display module assembly during the packaging process and the transportation process is reduced, the number of packages per unit volume is increased, and the packaging cost and the transportation cost are reduced. Meanwhile, the possibilities that the packaging bag is scratched and the riveting column 4 gets knocked or is knocked off are also reduced.

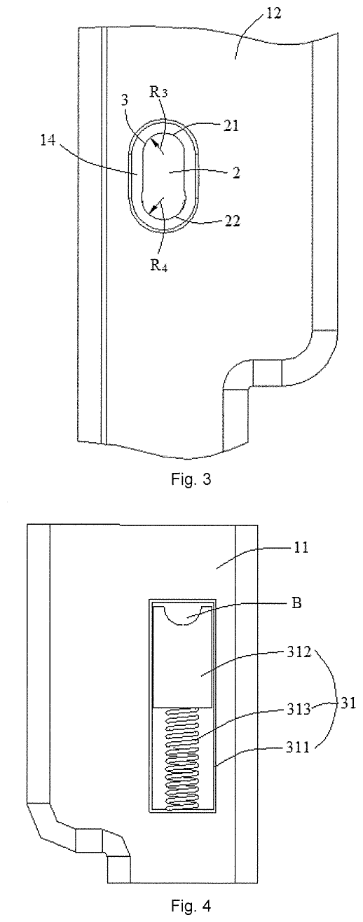

There are various implementations for the first connecting portion 3 and the plurality of second connecting portions 5. In an example, the first connecting portion 3 is an internal thread disposed on the inner surface of the through hole 2, and the plurality of second connecting portions 5 constitute external threads which are cooperatively connected with the internal thread. In another example, as shown in FIGS. 3, 4, 5, and 6, the first connecting portion 3 includes a hole wall of the through hole 2 and a stop assembly 31. The plurality of second connecting portions 5 are a plurality of first grooves. One of the plurality of first grooves is cooperatively engaged with the hole wall of the through hole 2. Optionally, widths of the plurality of first grooves are equal. The stop assembly 31 is configured to block a movement of the riveting column 4 to prevent the separation of the first groove the hole wall of the through hole 2 which are cooperatively engaged together. Compared with the internal thread provided on the inner surface of the through hole 2, the hole wall of the through hole 2 is thicker and accordingly its structural strength is higher, so that a stability of the connection between the riveting column 4 and the back plate 1 is higher.

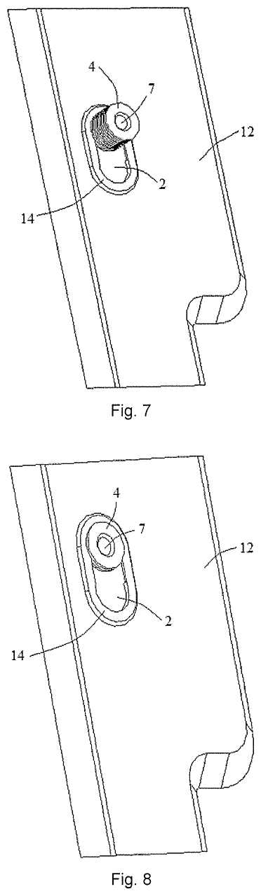

In order to further improve the stability of the connection between the riveting column 4 and the back plate 1, referring to FIG. 3 and FIG. 6, in some embodiments of the present disclosure, the through-hole 2 includes a first portion 21 having a radius R3 equal to a minimum radius R1 of the plurality of first grooves and a second portion 22 having a radius R4 greater than or equal to a maximum radius R2 of the plurality of first grooves. The minimum radius R1 of the plurality of first grooves is a radius of a bottom of the plurality of first grooves. The maximum radius R2 of the plurality of first grooves is a radius of a top of the plurality of first grooves. The first portion 21 and the second portion 22 are arranged in order from top to bottom and communicate with each other. The riveting column 4 may be moved between the first portion 21 and the second portion 22. Therefore, when the riveting column 4 is required to connected to the through hole 2, the riveting column 4 may be inserted into the through hole 2 from the second portion 22 having a radius greater than or equal to the maximum radius of the plurality of first grooves, and then moved upward to the first portion 21 having the radius equal to the minimum radius of the plurality of first grooves, so that the first grooves on the riveting column 4 and the hole wall of the first portion 21 are cooperatively engaged. Because the radius R3 of the first portion 21 is equal to the minimum radius R1 of the first grooves, an area of the engagement between the through hole 2 and the first grooves may be increased, thereby the stability of the connection between the riveting column 4 and the back plate 1 is further improved.

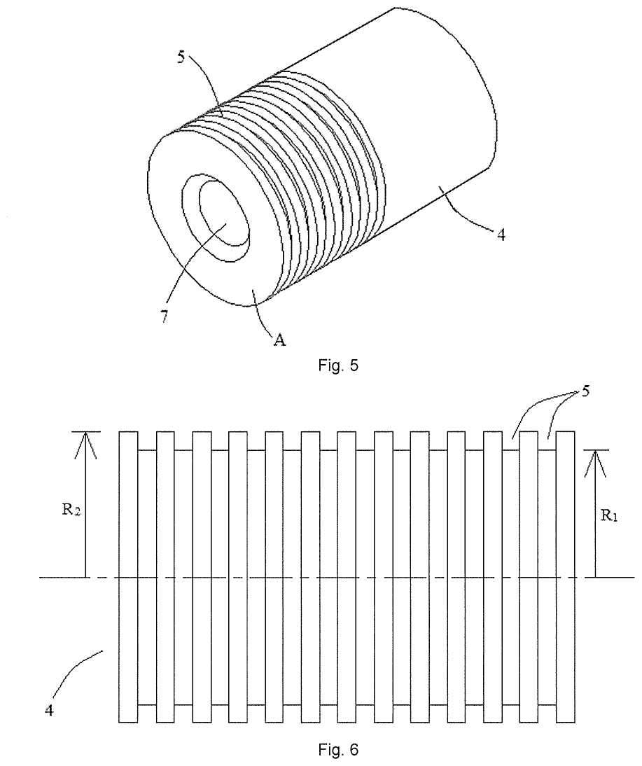

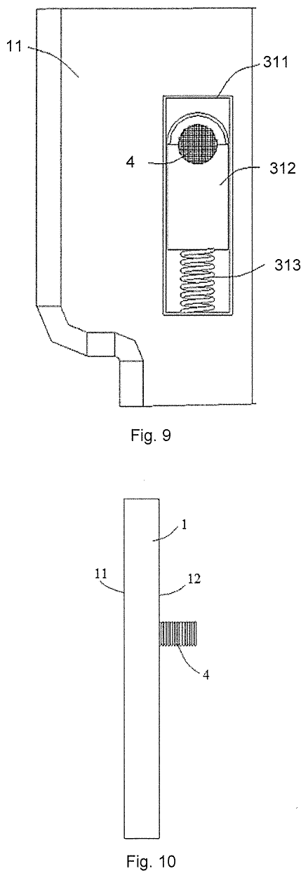

In an example, referring to FIGS. 4 and 9, the stop assembly 31 includes a guide groove 311, a stopper 312, and a spring 313. The guide groove 311 is disposed on the back plate 1. The stopper 312 is slidably fitted in the guide groove 311. One end of the spring 313 is fixed to an inner wall of the guide groove 311, and another end of the spring 313 is connected to the stopper 312. In cases where one end of the stopper 312 away from the spring 313 is in contact with the riveting column 4 and the spring 313 is in a compressed state, the stopper 312 may block the movement of the riveting column 4 to prevent the first grooves which are cooperatively engaged with the hole wall of the through hole 2 from being separated from the hole wall of the through hole 2. In cases where the riveting column 4 is removed from the through hole 2, the stopper 312 slides along the guide groove 311 under the elastic force of the spring 313 to block the through hole 2 so as to prevent foreign matters from entering the display module assembly through the through hole 2. In addition, since the elastic force of the spring 313 drives the stopper 312 to slide, and no manual drive is required, thereby simplifying the operation.

In an example, the plurality of first grooves are a plurality of annular grooves coaxial with the riveting column 4. One end of the stopper 312 away from the spring 313 is provided with a semi-circular groove B. The one end of the stopper 312 away from the spring 313 may be snap-fitted with one of the plurality of annular grooves through the semi-circular groove B, so as to block the movement of the riveting column 4 and prevent the first grooves which are cooperatively engaged with the hole wall of the through hole from being separated from the hole wall of the through hole. Through the cooperative engagement of the semi-circular groove B and the annular groove, the limiting effect to the riveting column 4 may be enhanced, thereby the stability of the connection between the riveting column 4 and the back plate 1 is improved.

In one example, the guide groove 311 is disposed on an inner surface 11 of the back plate 1, so that the stopper 312 may be located on an inner side of the back plate 1, thereby the stopper 312 is in contact with the position on the riveting column 4 located inside the back plate 1. Therefore, it is not necessary to leave a position on the riveting column 4 where the riveting column 4 in contact with the stopper 312 outside the back plate 1, so that the riveting column 4 may protrude more into the through hole 2, thereby the overall thickness of the display module assembly is reduced, meanwhile, the possibilities that the packaging bag is scratched and the riveting column 4 gets knocked or is knocked off are further reduced.

Referring to FIGS. 5, 6, 12, and 13, in an example, the plurality of second connecting portions 5 are arranged from the position close to the outer end A of the riveting column 4 to the middle of the riveting column 4. In another example, the plurality of second connecting portions 5 are also arranged from the position close to the outer end A of the riveting column 4 to the position away from the outer end A of the riveting column 4. In cases where the plurality of second connecting portions 5 are arranged from the position close to the outer end A of the riveting column 4 to the position away from the outer end A of the riveting column 4, there are more second connecting portions 5 to be connected with the first connecting portion 3 on the side surface of the riveting columns 4, so that an adjustable range for the overall thickness of the display module assembly is wider. Users may adjust the thickness of the display module assembly according to space size and personal preference to meet their own needs, thereby the user's satisfaction is improved.

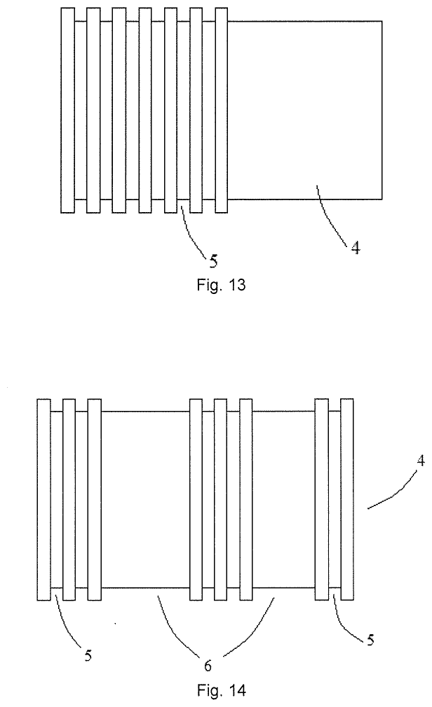

Further, referring to FIG. 14, in some embodiments of the present disclosure, at least one second groove 6 is also provided on the side surface of the riveting column 4, and a width of each of the at least one second groove 6 is not equal to a width of each of the plurality of first grooves. In cases where the number of the at least one second groove 6 is more than one, the widths of the plurality of second grooves 6 are not equal to each other. The second grooves 6 having different widths may be respectively snap-fitted with back plates having corresponding thickness, so that the riveting columns 4 may be applied to the back plate 1 having different thicknesses, so that the applicable range for the riveting columns 4 is relatively wide.

Referring to FIG. 2, in some embodiments of the present disclosure, a reinforcing rib 13 is provided on the back plate 1. The through hole 2 is formed on the reinforcing rib 13. With this arrangement, the thickness of the hole wall of the through hole 2 may be increased, thereby the structural strength of the hole wall is improved, and thus the connecting effect between the riveting column 4 and the back plate 1 is improved.

Referring to FIG. 3, in some embodiments of the present disclosure, a convex hull 14 is provided on the outer surface 12 of the back plate 1. The through hole 2 is formed on the convex hull 14. For example, the convex hull 14 may be formed by punching out of the inner surface 11 of the back plate 1 toward the outer surface 12, and then the through hole 2 may be punched out on the convex hull 14. In this way, the riveting column 4 and the through hole 2 may be far away from the inner side of the back plate 1, thereby the space inside of the back board 1 occupied by the riveting column 4 is reduced, thereby the interference caused by the riveting column 4 to other components inside the display module assembly is reduced.

Referring to FIG. 5, in some embodiments of the present disclosure, the outer end A of the riveting column 4 is provided with a threaded hole 7 for connecting with a screw, a bolt, or the like on the bracket.

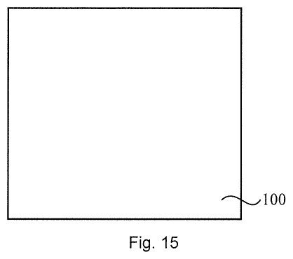

Referring to FIG. 15, some embodiments of the present disclosure further provide a display module assembly 100. The display module assembly 100 includes any one of the riveting column structure on the back plate of the above embodiments.

The display module assembly provided in some embodiments of the present disclosure includes any one of the riveting column structure on the back plate of the above embodiments. The back plate 1 of the riveting column structure on a back plate is provided with a through hole 2 passing through the back plate's inner and outer surfaces, and a first connecting portion 3 is provided at the through hole 2 of the back plate 1. The riveting column 4 is inserted into the through hole 2. A plurality of second connecting portions 5 are arranged on the side surface of the riveting column 4, and a plurality of second connecting portions 5 are arranged in order in a direction from the position close to the outer end A of the riveting column 4 to the position away from the outer end A of the riveting column 4, and each of the plurality of second connecting portions 5 may be respectively connected with the first connecting portion 3. Therefore, when the riveting column 4 is required to be connected with a bracket, one of the plurality of second connecting portion 5, which is far away from the outer end A of the riveting column 4, may be connected with the first connecting portion 3, so that a portion of the riveting column 4 exposed outside the back board 1 is long, thereby the connection with the bracket is facilitated. When the display module assembly is packaged and transported, one of the plurality of second connecting portions 5 close to the outer end A of the riveting column 4 may be connected with the first connecting portion 3, so that a portion of the riveting column 4 exposed outside the back plate 1 is short, thereby an overall thickness of the display module assembly is reduced. Accordingly, the space occupied by the display module assembly during packaging and transportation is reduced, the number of packages per unit volume is increased, and the packaging cost and the transportation cost are reduced. Meanwhile, the possibilities that the packaging bag is scratched and the riveting column 4 gets knocked or is knocked off are also reduced.

Other configurations and the like of the display module assembly related to the embodiments of the present disclosure are well known to any person skilled in the art and will not be described in detail herein.

The foregoing descriptions are merely specific implementation manners of the present disclosure, but the protection scope of the present disclosure is not limited thereto. Any person skilled in the art may easily think of the change or the replacement within the technical scope disclosed in the present disclosure, which should be within the scope of the disclosure. Therefore, the protection scope of the present disclosure should be based on the protection scope of the claims.

1. A riveting column structure on a back plate of a display module assembly, comprising:
a back plate provided with a through hole passing through the back plate's inner and outer surfaces, wherein a first connecting portion is provided at the through hole of the back plate; and
a riveting column inserted into the through hole, a plurality of second connecting portions are provided on a side surface of the riveting column, the plurality of second connecting portions are arranged in order in a direction from a position close to an outer end of the riveting column to a position away from the outer end of the riveting column, and each of the plurality of second connecting portions is respectively connected with the first connecting portion.

2. The riveting column structure on the back plate according to claim 1, wherein the first connecting portion comprises a hole wall of the through hole and a stop assembly, and the plurality of second connecting portions are a plurality of first grooves,
wherein, one of the plurality of first grooves is cooperatively engaged with the hole wall of the through hole, and the stop assembly is configured to block a movement of the riveting column to prevent the first grooves which are cooperatively engaged with the hole wall of the through hole from being separated from the hole wall of the through hole.

3. The riveting column structure on the back plate according to claim 2, wherein the through hole comprises:
a first portion having a radius substantially equal to a radius of a bottom of the plurality of first grooves; and
a second portion having a radius greater than or substantially equal to a radius of a top of the plurality of first grooves;
wherein, the first portion and the second portion are arranged in order from top to bottom and communicate with each other, and the riveting column is able to move between the first portion and the second portion.

4. The riveting column structure on the back plate according to claim 2, wherein the stop assembly comprises:
a guide groove disposed on the back plate;
a stopper slidably fitted in the guide groove; and
a spring, one end of which is fixed to an inner wall of the guide groove and another end of which is connected to the stopper;
in cases where one end of the stopper away from the spring is in contact with the riveting column and the spring is in a compressed state, the stopper blocks the movement of the riveting column to prevent the first grooves which are cooperatively engaged with the hole wall of the through hole from being separated from the hole wall of the through hole; and
in cases where the riveting column is removed from the through hole, the stopper slides along the guide groove under the elastic force of the spring to block the through hole.

5. The riveting column structure on the back plate according to claim 4, wherein the plurality of first grooves are a plurality of annular grooves coaxial with the riveting column, one end of the stopper away from the spring is provided with a semi-circular groove, and the one end of the stopper away from the spring is able to be snap-fitted with one of the plurality of annular grooves through the semi-circular groove.

6. The riveting column structure on the back plate according to claim 4, wherein the guide groove is disposed on an inner surface of the back plate.

7. The riveting column structure on the back plate according to claim 1, wherein the plurality of second connecting portions are arranged from a position close to the outer end of the riveting column to a position away from the outer end of the riveting column.

8. The riveting column structure on the back plate according to claim 2, wherein at least one second groove is further provided on a side surface of the riveting column, and a width of each of the at least one second groove is not equal to a width of each of the plurality of first grooves.

9. The riveting column structure on the back plate according to claim 2, wherein the back plate is provided with a reinforcing rib, and the through hole is formed on the reinforcing rib.

10. The riveting column structure on the back plate according to claim 1, wherein a convex hull is provided on an outer surface of the back plate, and the through hole is formed on the convex hull.

11. The riveting column structure on the back plate according to claim 1, wherein the outer end of the riveting column is provided with a threaded hole.

12. A display module assembly comprising the riveting column structure on the back plate according to any one of claim 1.

13. The riveting column structure on the back plate according to claim 2, wherein the through hole comprises:
a first portion having a radius substantially equal to a minimum radius of the plurality of first grooves; and
a second portion having a radius greater than or substantially equal to a maximum radius of the plurality of first grooves;
wherein, the first portion and the second portion are arranged in order from top to bottom and communicate with each other, and the riveting column is able to move between the first portion and the second portion.
